(19) United States
(12) Patent Application Publication
(10) Pub. No.: US 2010/0094678 A1
(43) Pub. Date: Apr. 15, 2010

(54) SYSTEM AND METHOD FOR PROVIDING DELAY NOTIFICATIONS

(75) Inventors: Shekhar Gupta, Overland Park, KS (US); Kelsyn D.S. Rooks, Overland Park, KS (US); Jeffrey Sweeney, Olathe, KS (US); Mark Wilmoth, Gardner, KS (US); Kendra Dwyer, Wellsville, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/249,705

(22) Filed: Oct. 10, 2008

(51) Int. Cl. G06F 17/30

(52) U.S. Cl. 705/9

(57) ABSTRACT

The disclosed embodiments present a system and method for providing delay notifications to attendees/virtual receptionists associated with an identified delayed calendar appointment. In addition, the disclosed embodiments provide automatic rescheduling of a delayed calendar appointment. Further, the disclosed embodiments provide advance tracking delay notifications by monitoring a user's current location in relation to a location of a scheduled calendar appointment.

### BACKGROUND OF THE INVENTION

1. Field of the Invention

The principles of the present invention relate to computers, and more specifically, to providing appointment notifications associated with a calendar appointment.

2. Description of the Related Art

With the advent of computers, many people have moved away from having physical calendars to using electronic calendars for keeping track of appointments and other important dates. Examples of electronic calendars include Microsoft® Outlook®, Google® Calendar™, and Yahoo!® Calendar™ Most electronic calendars allow a user to schedule appointments by selecting a time and date. In addition, some electronic calendars allow a user to specify a location associated with the appointment. Further, some electronic calendars provide pop-up reminders to a user of an upcoming appointment.

### SUMMARY

According to one embodiment of the present invention, a method for providing notifications of appointment delays is presented. The method includes associating calendar appointments of a first user with a first virtual receptionist. The first virtual receptionist is configured to communicate with a second virtual receptionist. The second virtual receptionist is associated with calendar appointments of a second user. In response to a determination of a delay in start time associated with a calendar appointment between the first user and the second user, the first virtual receptionist notifies the second virtual receptionist of the delay.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 depicts a network environment in which the illustrative embodiments may be implemented;

FIG. 1A depicts a local environment in which the illustrative embodiments may be implemented;

FIG. 2 is a high level component diagram of a data processing system in which the illustrative embodiments may be implemented;

FIG. 3 is an embodiment of a graphical user interface for entering a calendar appointment;

FIG. 4 is an embodiment of a virtual receptionist for providing notifications of appointment delays;

FIG. 5 is an embodiment of a process for providing appointment notifications in accordance with the disclosed embodiments;

FIG. 6 is an another embodiment of a process for providing appointment notifications and rescheduling a delayed calendar appointment; and

FIG. 7 is an embodiment of a process for identifying a delayed calendar appointment.

### DETAILED DESCRIPTION OF THE DRAWINGS

The disclosed embodiments automatically provide appointment notifications associated with a delayed calendar appointment. The calendar appointments of a user are associated with a virtual receptionist. A virtual receptionist is a computer program that monitors the associated calendar appointments of a user and notifies attendees of a calendar appointment of a delay in response to identifying a delayed calendar appointment. A delayed calendar appointment is a calendar appointment that is identified as not starting and/or not anticipated to start at a scheduled start time.

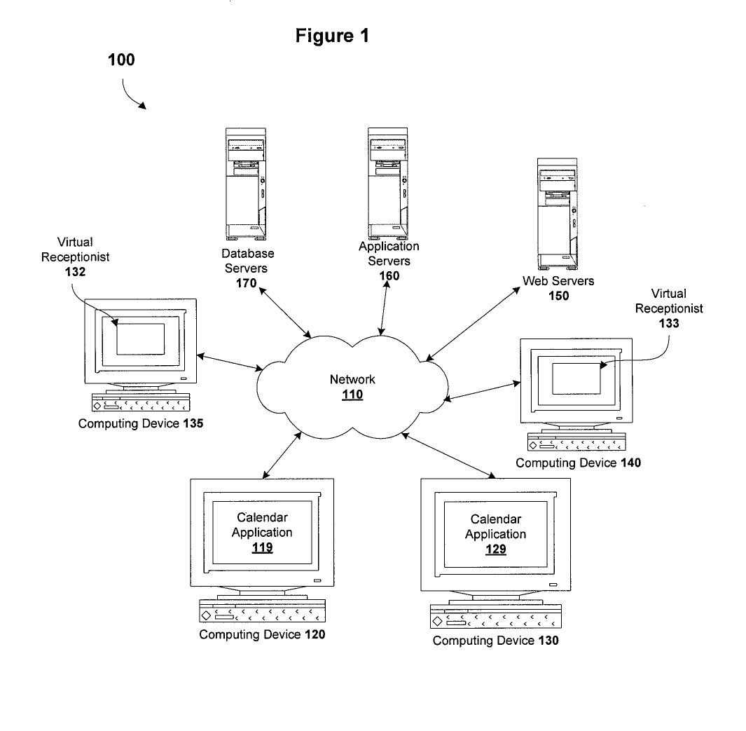

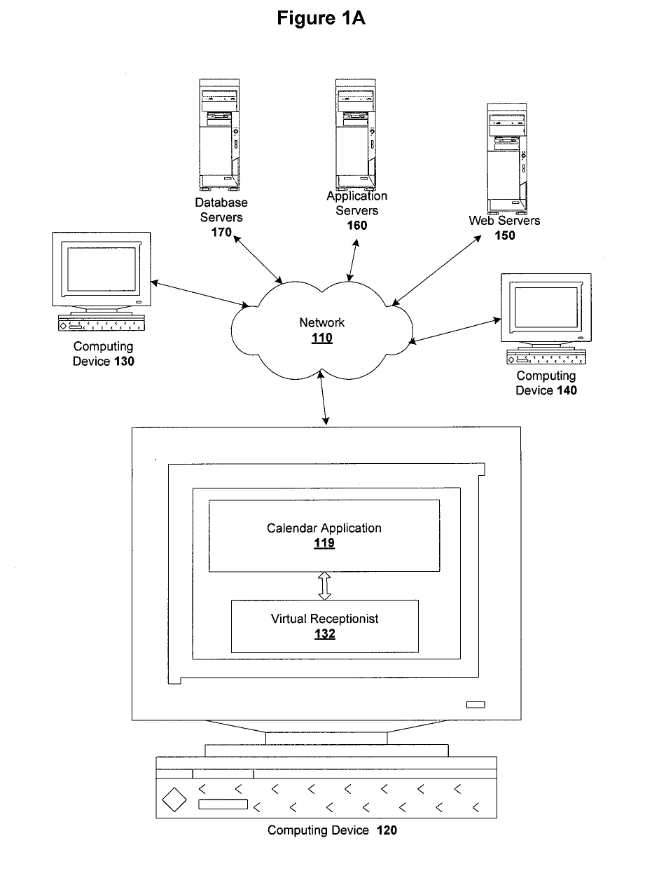

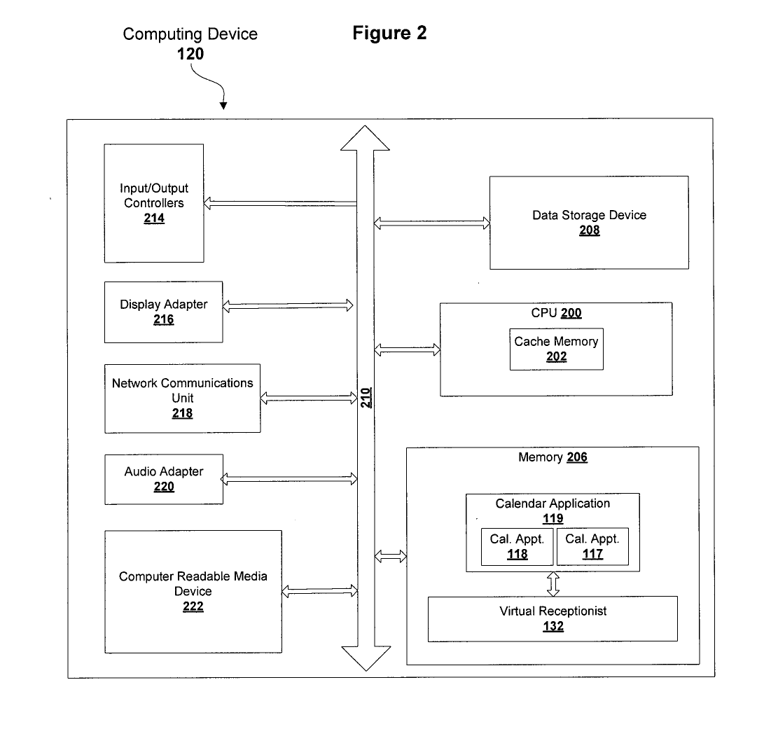

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a network environment 100 in which the illustrative embodiments may be implemented. Network environment 100 comprises network 110, which is the medium used to provide communications links between various devices and computers, such as, but not limited to, computing device 120, computing device 130, computing device 135, computing device 140, web servers 150, application servers 160, and database servers 170 connected together within network environment 100. Network 110 may include connections, such as wire, wireless communication links, or fiber optic cables.

Web servers 150, application servers 160, and database servers 170 comprises one or more servers, such as, but not limited to, IBM System p® servers. In addition, computing device 120, computing device 130, computing device 135, and computing device 140 may be, for example, personal computers, network computers, personal digital assistants (PDAs), and/or smart phones. In the depicted example, web servers 150, application servers 160, and database servers 170 provide data and/or services, such as, but not limited to, data files, operating system images, and applications to computing device 120, computing device 130, computing device 135, and computing device 140. Network environment 100 may include additional servers, clients, and other devices not shown.

In some embodiments, network 110 is the Internet. The Internet is a global system of interconnected computer networks that interchange data using the standardized Internet Protocol Suite (TCP/IP). The Internet includes millions of private and public networks that are linked by copper wires, fiber-optic cables, wireless connections, and other technologies. Of course, network 110 may also be implemented as a number of different types of networks, such as, but not limited to, an intranet, a local area network (LAN), or a wide area network (WAN).

In accordance with some embodiments, a first virtual receptionist 132 monitors calendar appointments of a calendar application 119 associated with a first user for providing delayed appointment notifications. In some embodiments, virtual receptionist 132 may request and receive appointment related information from calendar application 119. Alternatively, in some embodiments, calendar application 119 may routinely send appointment related information to virtual receptionist 132. Similarly, in some embodiments, a second virtual receptionist 133 may monitor calendar appointments of a calendar application 129 associated with a second user for providing delayed appointment notifications.

In some embodiments, if the first user and the second user are attendees of the same calendar appointment, the first virtual receptionist may be configured to communicate with the second virtual receptionist and vice versa. For example, in some embodiments, an IP address and/or a telephone number may be assigned to each virtual receptionist 132 and 133. Therefore, the first virtual receptionist 132 may be configured to communicate with the second virtual receptionist 133 using the IP address and/or telephone number of the second virtual receptionist 133 and vice versa. Further, in some embodiments, the first virtual receptionist 132 may be configured to notify the second virtual receptionist 133, and/or vice versa, of a delay in response to a determination of a delay in start time associated with a calendar appointment between the first user and the second user.

Alternatively, in some embodiments, if an attendee of a calendar appointment does not have a virtual receptionist, the first virtual receptionist 132 may be configured to directly notify the attendee, e.g., the second user, of a delay associated with a calendar appointment between the first user and the attendee. The delay notifications may be in the form of, but are not limited to, an electronic mail message, a text message using Short Message Service (SMS), and/or a voice message.

As depicted in FIG. 1, in some embodiments, virtual receptionist 132 may reside on a computing device 135 remote from calendar application 119. Of course, virtual receptionist 132 may also reside on a server, such as, but not limited to, application servers 160. FIG. 1 is intended as an example, and not as an architectural limitation for the different illustrative embodiments. For example, in some embodiments, the calendar appointments associated with a user may be monitored by more than one virtual receptionists and/or one virtual receptionist may monitor calendar appointments associated with more than one user.

In addition, in some embodiments, the virtual receptionist may be a program locally installed on the same computing device associated with a calendar application. For example, virtual receptionist 132 may reside on the same computing device 120 as calendar application 119 as depicted in FIG. 1A. In some embodiments, virtual receptionist 132 may use an application programing interface (API) to retrieve appointment related data from calendar application 119. Alternatively, in some embodiments, virtual receptionist 132 may be incorporated as a part of calendar application 119 and/or vice versa. Further, in some embodiments, a user may be required to register calendar appointments that the user desires a virtual receptionist to monitor.

FIG. 2 is an embodiment of computing device 120 in accordance with the embodiment depicted in FIG. 1A. In this embodiment, computing device 120 includes communications bus 210, which provides communications between central processing unit (CPU) 200, memory 206, data storage device 208, input/output (I/O) controllers 214, display adapter 216, network communications unit 218, audio adapter 220, and computer readable media device 222.

CPU 200 executes instructions for software that may be loaded into memory 206. CPU 200 may be a set of one or more processors or may be a multi-processor core, depending on the particular implementation. Further, CPU 200 may include one or more levels of cache memory, such as, but not limited to, cache memory 202. Cache memory 202 is used by CPU 200 to store copies of the data from the most frequently used main memory locations to reduce the average time to access memory.

Memory 206 is used to retain digital data used for processing. In some embodiments, memory 206 may be a random access memory SAM). RAM memory allows the stored data to be accessed in any order as opposed to storage mechanisms, such as tapes and magnetic discs. In addition, memory 206 may include any other suitable volatile or non-volatile storage device.

CPU 200 loads computer executable instructions, such as, but not limited to, calendar application 119 into memory 206 for execution. Calendar application 119 may include one or more calendar appointments, such as, but not limited to, calendar appointment 117 and calendar appointment 118. In addition, CPU 200 may load computer executable instructions for virtual receptionist 132 into memory 206 for identifying delayed calendar appointments associated with calendar application 119.

Data storage device 208 may take various forms depending on the particular implementation. For example, data storage device 208 may be a hard drive, a flash memory, a rewritable optical disk, a rewritable magnetic tape, or some combination of the above. The media used by data storage device 208 also may be removable, such as, but not limited to, a removable hard drive.

Input/output unit 214 may include one or more of the same and/or different types of data ports used for connecting external devices to computing device 120. Input/output unit 214 may include a serial port, a parallel port, an accelerated graphics port, and a universal serial bus (USB) port. For example, input/output unit 214 may be used to connect computer peripherals, such as mice, keyboards, PDAs, gamepads and joysticks, scanners, digital cameras, printers, personal media players, and flash drives.

Display adapter 216 is used to generate and output images to a display. Display adapter 216 may be a dedicated expansion card that is plugged into a slot on the motherboard of computing device 120 or may be a graphics controller integrated into the motherboard chipset. In addition, display adapter 216 may include dedicated memory and one or more processing units.

Network communications unit 218 provides for communications with other data processing systems or devices. In these examples, network communications unit 218 is a network interface card. Modems, cable modem, Ethernet cards, and wireless interface cards are just a few of the currently available types of network interface adapters. Network communications unit 218 may provide communications through the use of physical and/or wireless communications links.

Audio adapter 220 facilitates the input and output of audio signals to and from computing device 120. For example, audio adapter 220 may provide the audio component for multimedia applications, such as music composition, editing video or audio, presentation/education, and/or entertainment, such as video games. In some embodiments, audio adapter 220 may be an expansion card added to computing device 120 to provide for audio capability.

Computer readable media device 222 provides a mechanism for reading and writing to tangible forms of computer media, such as, but not limited to, a floppy disc, a compact disc (CD), a digital versatile disc (DVD), and memory cards. For example, CPU 200 may use computer readable media device 222 to read instructions stored on a computer media for executing the computer executable instructions of virtual receptionist 132.

The different components illustrated for computing device 120 are not meant to provide architectural limitations to the manner in which different embodiments may be implemented. For example, the different illustrative embodiments may be implemented in a data processing system including components in addition to or in place of those illustrated for computing device 120.

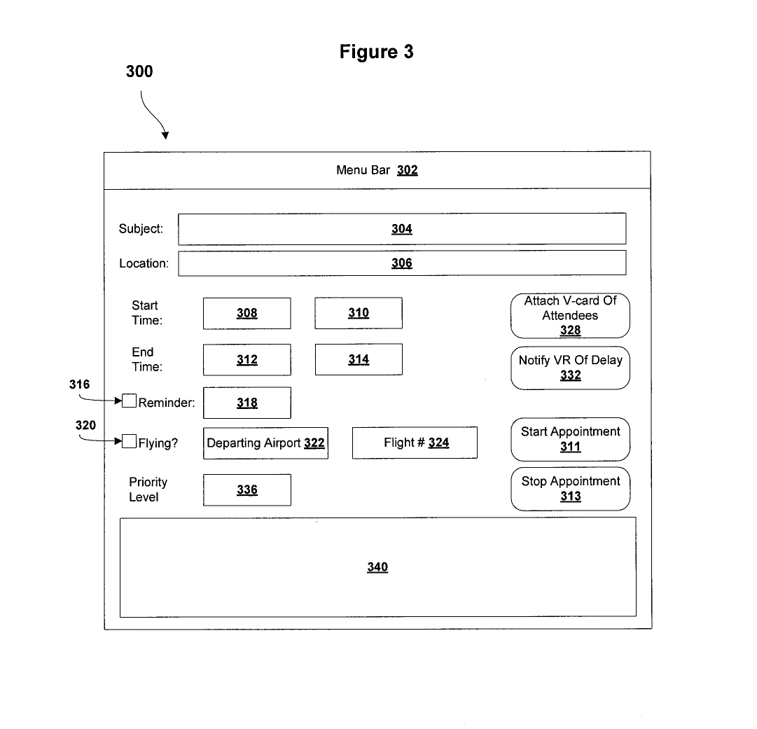

FIG. 3 is an embodiment of a graphical user interface 300 for entering a calendar appointment, such as, but not limited to, calendar appointment 118. Graphical user interface 300 is provided as an example and does not imply a particular design and/or limitation. The depicted data fields and features of graphical user interface 300 may be modified, combined, and/or deleted. In addition, additional data fields and function may be added to graphical user interface 300. Further, in some embodiments, certain data entry fields of graphical user interface 300 may remain empty.

Graphical user interface 300 includes a menu bar 302. Menu bar 302 may include one or features associated with creating a new calendar appointment. For example, menu bar 302 may include features for spellchecking, formatting, and/or saving a new calendar appointment. In addition, menu bar 302 may include a feature for inviting other attendees to a calendar appointment.

In addition, graphical user interface 300 includes a subject data entry field 304 and a location data entry field 306. Subject data entry field 304 may be used to specify a subject/event associated with the calendar appointment. In addition, location data entry field 306 may be used to specify a location associated with calendar appointment.

Graphical user interface 300 also includes a start date data entry field 308 and a start time data entry field 310 for selecting a start date and time associated with a calendar appointment. In some embodiments, start date data entry field 308 and start time data entry field 310 may comprise a pull down menu of dates and times to allow a user to select a desired date and time. Similarly, in some embodiments, graphical user interface 300 includes an ending date data entry field 312 and an ending time data entry field 314.

Additionally, in some embodiments, graphical user interface 300 may allow a user to select a reminder option 316 for presenting the user with reminders of the created calendar appointment. For example, a user may specify in reminder data entry field 318 that a reminder be sent to the user 15 minutes prior to the specified start date and time.

In this illustrative embodiment, graphical user interface 300 may be configured to enable users to select a flight option 320. In response to selecting flight option 320, a user may select a departing airport in departing airport data field 322 and may enter in a flight number in flight number data field 324. The flight information may be used by a virtual receptionist in identifying delayed calendar appointments. For example, in some embodiments, a virtual receptionist may monitor the flight schedule associated with the entered flight information to identify delayed calendar points.

In addition, in some embodiments, graphical user interface 300 may include an attach virtual card option 328 for attaching the contact information of the attendees associated with this calendar appointment. For example, by selecting attached virtual card option 328, a user may be presented with a contacts list in which the user may select the attendees associated with this calendar appointment. Therefore, a virtual receptionist monitoring this calendar appointment may automatically notify the proper attendees have of any delay.

Further, in some embodiments, a user may retrieve a calendar appointment and initiate a delay notification to a virtual receptionist by selecting a delay notification option 332. In some embodiments, in response to receiving a user-initiated delay notification, graphical user interface 300 may also present an option for the user to enter an amount of time associated with the delay. In addition, in some embodiments, the user and/or the virtual receptionist may propose an alternative time for the delayed calendar appointment in conjunction with notifying the attendees of the delay.

In some embodiments, graphical user interface 300 may include a priority level data field 336. In these embodiments, a user may assign a priority level to a calendar appointment. For example, the user may rank the priority of the calendar appointment from 1 to 9, where a calendar appointment with a ranking of 9 has the highest priority. The priority level may be used to determine whether a delayed calendar appointment that may affect the scheduling of subsequent calendar appointments should be canceled and/or reschedule or whether the affected subsequent calendar appointments should be rescheduled.

Additionally, in some embodiments, graphical user interface 300 may include a start appointment button 311 and a stop appointment button 313. In these embodiments, a user may manually indicate when a scheduled appointment actually starts by using start appointment button 311 and when the scheduled appointment ends by selecting stop appointment button 313. In one embodiment, if virtual receptionist 132 does not receive the ending notification (i.e., a user selection of stop appointment button 313) within a specified time interval until the beginning of a subsequent calendar appointment, virtual receptionist 132 identifies the subsequent calendar appointment as a delayed calendar appointment. In some embodiments, virtual receptionist 132 maintains a log file of the start and stop times associated with the scheduled calendar appointments. Further, in some embodiments, virtual receptionist 132 analyzes the log file to determine a recommended amount of time to schedule for particular types of calendar appointments.

In some embodiments, additional notes/text may be associated with the calendar appointment in data entry field 340. For example, a user may enter a reminder note, such as, “Arrive early to meeting for setup.”

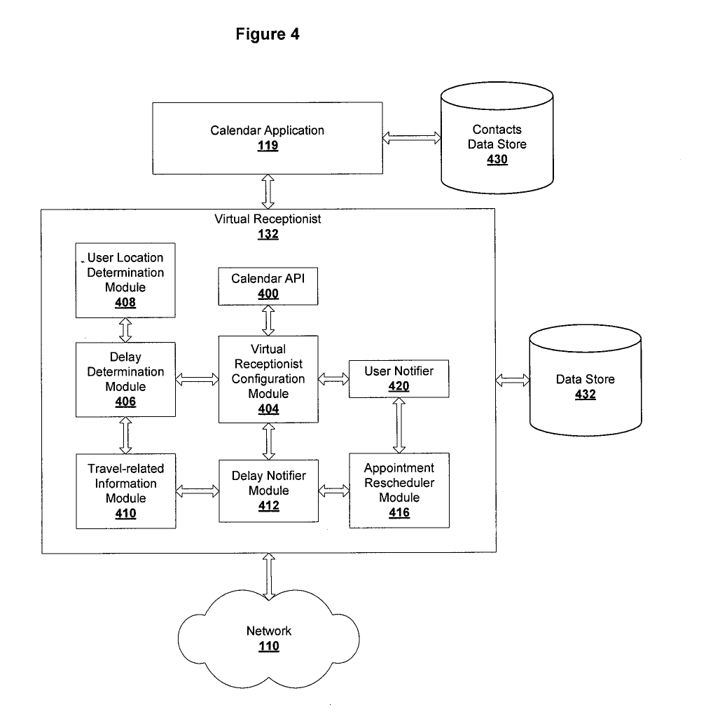

FIG. 4 is an embodiment of a virtual receptionist for providing notifications of appointment delays. Virtual receptionist 132 includes, among other things, a calendar application programming interface (API) 400, a virtual receptionist configuration module 404, a delay determination module 406, a user location determination module 408, a travel-related information module 410, a delay notifier module 412, an appointment rescheduler module 416, and a user notifier 420.

Calendar API 400 is a set of functions, procedures or classes used for accessing and retrieving appointment related data from calendar application 119. In some embodiments, calendar API 400 may be implemented as part of calendar application 119. For example, Google® Calendar™ Data API may be used to create new calendar appointments, edit or delete existing calendar appointments, and query for calendar appointments that match particular criteria.

Virtual receptionist configuration module 404 may be used to configure virtual receptionist 132. In some embodiments, virtual receptionist configuration module 404 may be used to assign an IP address to virtual receptionist 132 and configure virtual receptionist 132 communication protocols, such as, but not limited to, using the TCP/IP protocol for communicating with another virtual receptionist and/or for communicating directly to an attendee a calendar appointment using the Internet. In addition, in some embodiments, virtual receptionist configuration module 404 may be used for configuring user preferences, such as, but not limited to, canceling a calendar appointment if the delay exceeds a user specified amount of time and/or enabling the virtual receptionist to accept a proposed non-conflicting alternative time for rescheduling a delayed appointment.

Delay determination module 406 identifies delayed calendar appointments. In some embodiments, a delayed calendar appointment is identified by a user initiated action, such as, but not limited to, a user selecting delay notification option 332 as depicted in FIG. 3. Alternatively, in some embodiments, as depicted in FIG. 3, a user may notify a virtual receptionist when a calendar appointment ends. In these embodiments, virtual receptionist 132 may identify subsequent calendar appointments as delayed in response to not receiving a user indication that a prior calendar appointment has ended.

In addition, in some embodiments, delay determination module 406 identifies delayed calendar appointments by monitoring for delays occurring in an earlier calendar appointment that may have an effect on a subsequent calendar appointment, i.e., a delay having a cascading effect on subsequent calendar appointments. For example, suppose a calendar appointment is scheduled from 9:30 to 10:10 and requires the full amount of scheduled time. A subsequent calendar appointment is scheduled from 10:15 to 10:30. Thus, a delay of more than five minutes in the first appointment will result in a delay of the subsequent appointment. In such a case, the virtual receptionist may automatically notify an attendee of the subsequent appointment of the possible delay. For instance, this scenario may frequently occur at a doctor's office where patient appointments are normally scheduled one right after the other.

Furthermore, in some embodiments, delay determination module 406 identifies delayed calendar appointments by monitoring a users' current position with respect to an estimated travel time to a location of a calendar appointment. As will be further described, this may include monitoring traffic conditions and/or flight status information associated with a calendar appointment.

User location determination module 408 determines a location of a user. In some embodiments, virtual receptionist 132 may determine the user location as a location of a prior calendar appointment, such as, but not limited to, in the embodiment described above in which the user notifies the virtual receptionist when a calendar appointment ends. In addition, in some embodiments, user location determination module 408 determines an actual current location of a user using cellular triangulation and/or using geographical coordinates, such as, but not limited to, global positioning system (GPS) coordinates. Of course, the user may also specify a user location for a particular calendar appointment. For example, if a user knows that he will be out of town for a particular meeting, the user may specify a hotel location of where he will be staying as the user location.

Travel-related information module 410 retrieves travel-related information associated with the location of the calendar appointment from one or more network databases. For example, in some embodiments, travel-related information module 410 may retrieve a map/directions from a user location to the location of a calendar appointment for estimating the travel time. In addition, in some embodiments, travel-related information module 410 may retrieve traffic and weather conditions for determining the estimated travel time. Further, in some embodiments, travel-related information module 410 may retrieve and monitor flight information associated with a calendar appointment in identifying delayed calendar appointments. Alternatively, in some embodiments, travel-related information module 410 may periodically receive travel-related information, such as, but not limited to, traffic and weather conditions from one or more network databases and/or data services.

Delay notifier module 412 notifies other attendees associated with an identified delayed calendar appointment. In some embodiments, delay notifier module 412 retrieves the contact information associated with the specified attendees of the identified delayed calendar appointment from a contacts data store, such as, but not limited to, contacts data store 430. Contacts data store 430 may be a local data store associated with calendar application 119. In some embodiments, contacts data store 430 may be stored on a remote computing device, such as, but not limited to, Database Servers 170 is depicted in FIG. 1. In addition, in some embodiments, delay notifier module 412 determines whether a virtual receptionist is associated with an attendee and if so, delay notifier module 412 communicates the delay to the virtual receptionist.

In addition, in some embodiments, virtual receptionist 132 includes appointment rescheduler module 416. In response to identifying a delayed calendar appointment, appointment rescheduler module 416 determines whether the appointment should be canceled and/or rescheduled. For example, if the delay is greater than a user-specified period of time and/or the delay conflicts with subsequent calendar appointment having a higher priority level than the delayed calendar appointment, appointment rescheduler module 416 may determine that the identified delayed calendar appointment should be canceled and/or rescheduled. In such a case, in some embodiments, appointment rescheduler module 416 may determine an available time for rescheduling the delayed calendar appointment and proposed the available time to the other attendees/virtual receptionists associated with the delayed calendar appointment. Additionally, in some embodiments, a user may configure virtual receptionist 132 to automatically accept a proposed time from the other attendees/virtual receptionists for rescheduling an identified delayed calendar appointment if the proposed time does not conflict with any other calendar appointment. For instance, a user causing a delay may wish to make rescheduling of the delayed calendar appointment as convenient as possible for the other attendees.

User notifier 420 notifies the user associated with the calendar appointments of any changes to a calendar appointment. For example, user notifier 420 may send an e-mail to the user notifying the user that an identified delayed calendar appointment has been canceled and/or rescheduled. This cancellation may occur because of a delay resulting from the user and/or may occur because of a delay resulting from one of the attendees of the calendar appointment. Of course, other forms of user notifications may be used.

In addition, in some embodiments, virtual receptionist 132 stores and retrieves data from a data store, such as, but not limited to, data store 432. Data store 432 may include one or more, local or remote, databases. For example, in some embodiments, data store 432 may include personal data associated with the user, such as, but not limited to, the user name, home address, work address, email address, and/or other user-specified preferences.

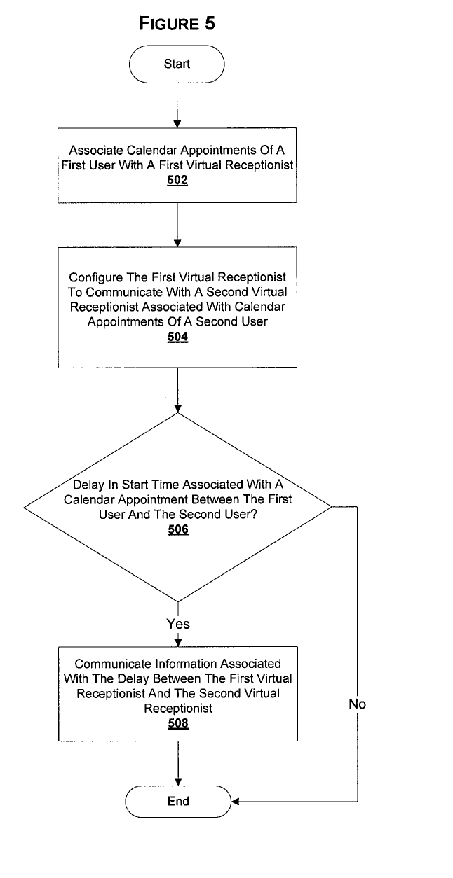

With reference now to FIG. 5, an embodiment of a process 500 for providing appointment notifications is presented. Process 500 begins by associating calendar appointments of a first user with a first virtual receptionist at step 502. At step 504, the process configures the first virtual receptionist to communicate with a second virtual receptionist associated with calendar appointments of a second user. The process, at step 506, determines whether a start time associated with a calendar appointment between the first user and the second user is delayed. In response to a determination of a delay in start time associated with a calendar appointment between the first user and the second user, the process communicates information associated with the delay between the first virtual receptionist and the second virtual receptionist at step 508, with process 500 terminating thereafter.

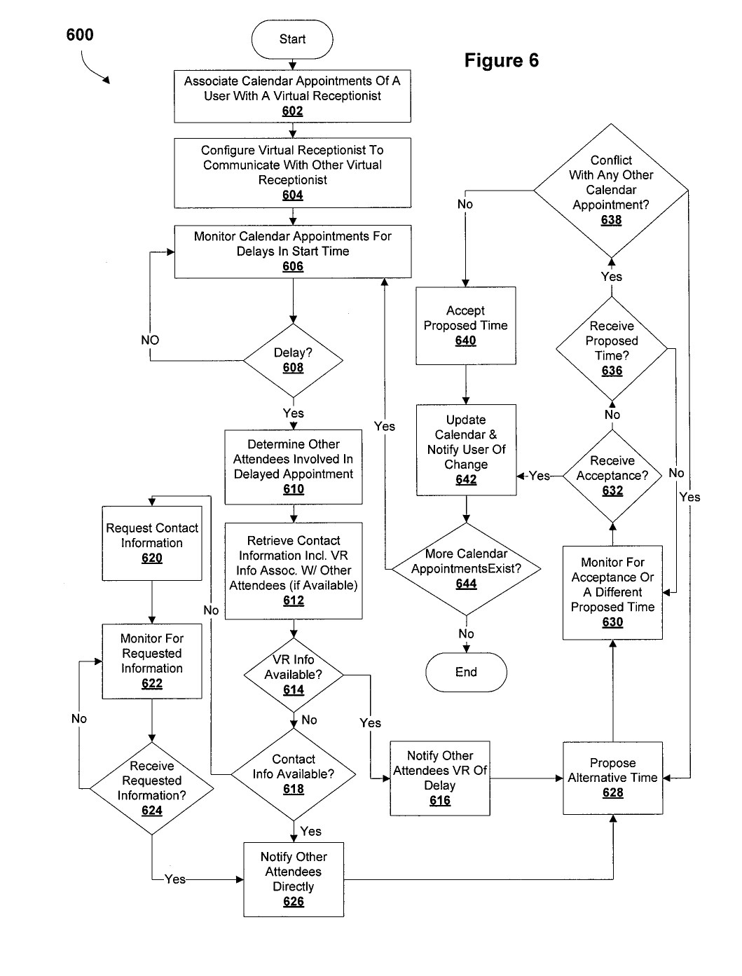

FIG. 6 is an embodiment of a process 600 for notifying and rescheduling a delayed calendar appointment. The disclosed process embodiments including process 600 may be executed by a processing unit, such as, but not limited to, CPU 200 of computing device 120 as depicted in FIG. 2. Further, the disclosed process embodiments are intended solely as illustrative embodiments and do not imply a particular implementation and/or limitation in regards to the disclosed embodiments.

Process 600 begins by associating calendar appointments of a user with a virtual receptionist at step 602. In some embodiments, a user registers calendar appointments with the virtual receptionist. Alternatively, in some embodiments, the virtual receptionist is given access to the calendar appointments.

At step 604, the process configures the virtual receptionist to be able to communicate with other virtual receptionists associated with attendees of the calendar appointments of the user. This step may include assigning the virtual receptionist with a unique IP address and providing the virtual receptionist with the IP addresses of other virtual receptionists. This step may also include providing the virtual receptionist with the contact information, such as, but not limited to, telephone numbers and/or email addresses, of attendees not associated with any virtual receptionist.

The process then monitors the calendar appointments for any delays in start time at step 606. The process for identifying a delayed calendar appointment will be further described in FIG. 6. If no appointment delays are identified at step 608, the process continues to monitor the calendar appointments for delays in start time at step 606. The monitoring process may be continuous or may be performed periodically at specified intervals. However, if a delayed appointment is identified at step 608, the process determines the other attendees associated with the delayed calendar appointment at step 610.

At step 612, the process retrieves the contact information of the other attendees and/or the contact information of the virtual receptionists, if any, associated with the other attendees. If a virtual receptionist is determined to be associated with an attendee at step 614, the process notifies the virtual receptionist of the attendee at step 616.

However, if a virtual receptionist is not associated with an attendee, the process, at step 618, determines if sufficient contact information was retrieved at step 612 to notify the attendee. If sufficient contact information is available, the process notifies the attendee directly at step 626. If sufficient contact information is not available, the process requests the additional contact information from the user at step 620. The process then monitors for the requested information at step 622. If the requested information is received at step 624, the process notifies the attendee directly at step 626.

Additionally, in some embodiments, the virtual receptionist may attempt to reschedule a delayed calendar appointment by proposing an alternative time for the identified delayed calendar appointment at step 628. For example, in some embodiments, if the delay is greater than a user-specified period of time and/or the delay conflicts with a subsequent calendar appointment having a higher priority level than the delayed calendar appointment, the virtual receptionist may determine that the identified delayed calendar appointment should be canceled and rescheduled.

At step 630, the process monitors for a response to the proposed time. In addition, in some embodiments, the process may also monitor for a proposed time received from an attendee and/or the virtual receptionist of an attendee. If at step 632, the process receives acceptance of a proposed time, the process updates the calendar appointment with the new time and notifies the user of the change to the calendar appointment at step 642. The process determines, at step 644, whether additional calendar appointments exist for monitoring. If calendar appointments requiring monitoring exist, then the process returns to step 606, else the process terminates.

However, if the process receives a propose/counterproposal time for rescheduling the identified delayed calendar appointment at step 636, the process determines if the propose time conflicts with any calendar appointment of the user at step 638. If a conflict exists, the process returns to step 628 and proposes an alternative time. If a conflict does not exist, the process accepts the propose time at step 640. The process then updates the calendar appointment with the new time and notifies the user of the change to the calendar appointment at step 642. Of course, in some embodiments, prior to rescheduling a calendar appointment the process may notify the user of the proposed rescheduled time and awaits permission from the user prior to accepting and/or rescheduling a calendar appointment.

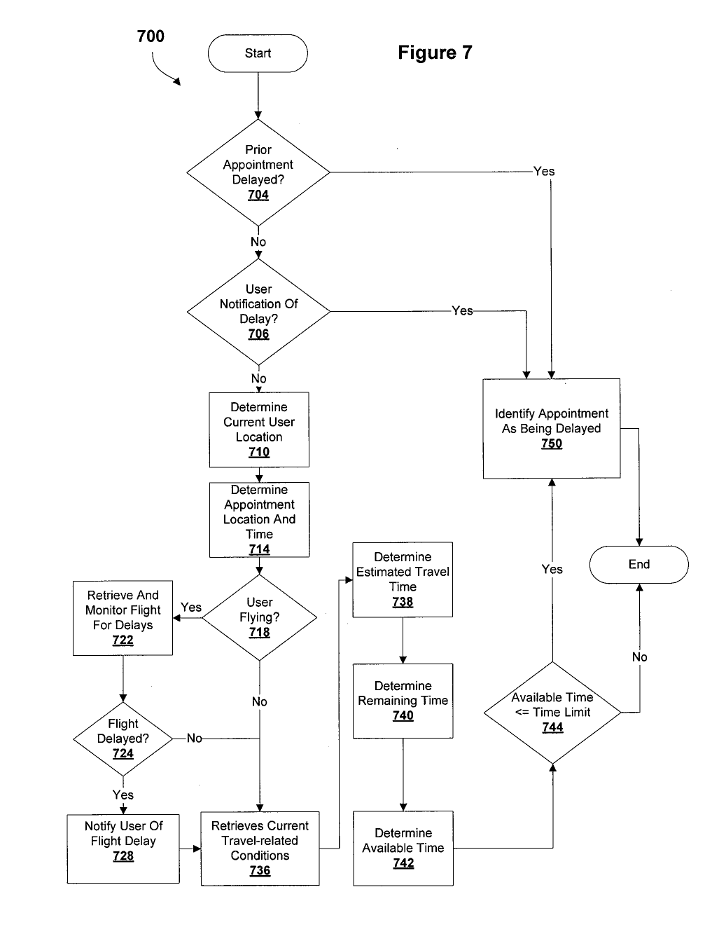

With reference now to FIG. 7, an embodiment of a process 700 for identifying a delayed calendar appointment is presented. Process 700 is not intended to imply an exact sequential series of steps in which the disclosed embodiments must be performed. Instead, process 700 is merely provides one embodiment for identifying a delayed calendar appointment.

Process 700 begins, at step 704, by determining if a delay of an earlier calendar appointment will result in a delay of a subsequent calendar appointment. For example, if an calendar appointment requires a set number of minutes and a subsequent calendar appointment is scheduled immediately afterwards, then any delay in the prior appointment will result in a delay of the subsequent calendar appointment(s). Thus, a delay in one appointment may result in multiple delays of subsequent appointments. If such a scenario is identified at step 704, then the process identifies the affected subsequent calendar appointments as being delayed at step 744, with process terminating thereafter.

Alternatively, at step 706, the process may receive a user initiated notification of a delay to a calendar appointment. If the process does receive a user initiated notification of a delay to a calendar appointment, the process identifies the calendar appointment as being delayed at step 744, with process terminating thereafter. In some embodiments, the process may request additional information from the user about the delay, such as, but not limited to, the amount of time associated with the delay and/or whether the user desires to cancel and/or reschedule the delayed calendar appointment.

In addition, in some embodiments, the process may monitor a current location of a user to provide advance tracking delay notifications. For instance, suppose a user is on his way to a scheduled calendar appointment and unforeseen traffic condition occurs. With advance delay notifications, the virtual receptionist may automatically determine that the user will be late for the appointment by monitoring the user's current position and other travel related conditions, such as, but not limited to, traffic, weather, and/or flight status information. If the virtual receptionist determines that the user will be late to the scheduled calendar appointment, the virtual receptionist may automatically notify the other attendees associated with the calendar appointment of the delay. Further, in some embodiments, the virtual receptionist may provide an estimated time associated with the delay.

For these embodiments, the process determines the user's current location at step 710. At step 714, the process determines a location and start time for the next calendar appointment. At step 718, the process determines whether the user is flying to the location of the next calendar appointment. For example, process may retrieve the flight information associated with the calendar appointment as shown in FIG. 3. If flight information is associated with the calendar appointment, the process, at step 722, retrieves and monitors the flight status associated with the retrieved flight information for any changes and/or delays. If the flight is determined to be delayed at step 724, the process notifies the user of the flight delay at step 728. The process then proceeds to step 736.

However, if at step 718, the process determines that the user is not flying to the next scheduled calendar appointment, the proceeds directly to step 736. At step 736, the process retrieves current travel-related conditions, such as, but not limited to, traffic conditions, construction, and/or weather conditions that may affect the user's travel time. At step 738, the process, taking into account the current travel related conditions, determines an estimated travel time from the user's current position to the location associated with the next scheduled calendar appointment and/or an airport location in the event that the user is flying.

At step 740, the process determines a remaining time until the start of the next scheduled calendar appointment or a departure time associated with the retrieved flight information. At step 742, the process determines an available time by subtracting the estimated travel time from the remaining time. At step 744, the process determines whether the available time is less than or equal to a specified time limit. For example, a user may specify the time limit equal to 5 minutes because the user requires five minutes to find parking, walked to the office, and be ready for the meeting. In some embodiments, if the time limit is not pre-specified, a default value may be used, such as, but not limited to, zero. Thus, in these embodiments, a calendar appointment is identified as delayed if the estimated travel time is greater than or equal to the available time. If the available time is less than or equal to a specified time limit, the process identifies the calendar appointment as delayed at step 750 with the process terminating thereafter. If the available time is greater than the pre-specified time limit, then the process terminates. As previously stated, process 700 may be repeated/performed continuously or may be performed periodically at specified interval for identifying a delayed calendar appointment.

Accordingly, the disclosed embodiments present a system and method for providing automatic delay notifications to attendees/virtual receptionists associated with an identified delayed calendar appointment. In addition, the disclosed embodiments provide automatic rescheduling of a delayed calendar appointment. In at least one embodiment, the rescheduling process utilizes appointment priorities established by a user. Further, the disclosed embodiments provide advance tracking delay notifications by monitoring a user's current location in relation to a location of a scheduled calendar appointment.

As will be appreciated by one skilled in the art, the disclosed embodiments may be embodied as a system, method, or computer program product. Accordingly, the disclosed embodiments may be implemented entirely with hardware or as a software embodiment (including firmware, resident software, micro-code, etc.) or an embodiment combining software and hardware aspects that may all generally be referred to herein as a “circuit,” “module” or “system.” Furthermore, the disclosed embodiments may take the form of a computer program product embodied in any tangible medium of expression having computer-usable program code embodied in the medium.

Computer program code for carrying out operations of the present invention may be written in any combination of one or more programming languages, including an object oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (IAN), or the connection may be made to an external computer (for example, through the Internet using an Internet Service Provider).

The disclosed embodiments are described above with reference to flowchart illustrations and/or block diagrams. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed:

1. A method for providing appointment notifications, the method comprising:
associating calendar appointments of a first user with a first virtual receptionist;
configuring the first virtual receptionist to communicate with a second virtual receptionist associated with calendar appointments of a second user; and
responsive to a determination of a delay in start time associated with a calendar appointment between the first user and the second user, communicating information associated with the delay between the first virtual receptionist and the second virtual receptionist.

2. The method of claim 1, further comprising configuring the first virtual receptionist to propose an alternative time for the calendar appointment to the second virtual receptionist.

3. The method of claim 1, further comprising configuring the first virtual receptionist to accept a proposed alternative time for the calendar appointment from the second virtual receptionist in response to a determination that the proposed alternative time does not conflict with another appointment of the first user.

4. The method of claim 1, further comprising configuring the first virtual receptionist to notify the first user of any changes made to the calendar appointment.

5. The method of claim 1, wherein the determination of the delay in start time includes receiving a user-notification from the first user.

6. The method of claim 1, wherein the determination of the delay in start time includes monitoring earlier calendar appointments of the first user that may affect the start time of the calendar appointment between the first user and the second user.

7. The method of claim 1, wherein the determination of the delay in start time includes monitoring flight information associated with the first user traveling to a location of the calendar appointment.

8. The method of claim 1, wherein the determination of the delay in start time includes:
determining a current location of the first user;
determining an estimated travel time to a location associated with the calendar appointment based on the current location of the first user;
calculating a remaining time until the start time associated with the calendar appointment;
determining an available time by subtracting the estimated travel time from the remaining time; and
determining that the start time associated with the calendar appointment will be delayed if the available time is less than or equal to a predefined limit.

9. The method of claim 8, wherein the determination of the estimated travel time includes retrieving real-time traffic conditions associated with traveling from the current location to the location associated with the calendar appointment.

10. A method for providing appointment notifications, the method comprising:
associating calendar appointments of a first person with a virtual receptionist; and
responsive to a determination of a delay in start time associated with a calendar appointment between the first person and a second person, configuring the virtual receptionist to notify the second person of the delay.

11. The method of claim 10, further comprising configuring the virtual receptionist to propose an alternative time for the calendar appointment to the second person.

12. The method of claim 10, further comprising:
receiving a proposed alternative time for the calendar appointment from the second person;
determining whether the proposed alternative time conflicts with another appointment of the first person; and
responsive to a determination that the proposed alternative time does not conflict with another appointment of the first person, configuring the virtual receptionist to accept the proposed alternative time for the calendar appointment.

13. The method of claim 10, further comprising configuring the virtual receptionist to notify the first person of any changes made to the calendar appointment.

14. The method of claim 10, wherein the determination of the delay in start time includes receiving a user-notification from the first person.

15. The method of claim 10, wherein the determination of the delay in start time includes monitoring earlier calendar appointments of the first person that may affect the start time of the calendar appointment between the first person and the second person.

16. The method of claim 10, wherein the determination of the delay in start time includes monitoring flight information associated with the first person traveling to a location of the calendar appointment.

17. The method of claim 10, wherein the determination of the delay in start time includes:
determining a current location of the first person;
determining an estimated travel time to a location associated with the calendar appointment based on the current location of the first person;
calculating a remaining time until the start time associated with the calendar appointment;
determining an available time by subtracting the estimated travel time from the remaining time; and
determining that the start time associated with the calendar appointment will be delayed if the available time is less than or equal to a predefined limit.

18. The method of claim 17, wherein the determination of the estimated travel time includes retrieving real-time traffic conditions associated with traveling from the current location to the location associated with the calendar appointment.

19. A system for providing appointment notifications, the system comprising:
a data bus system;
memory coupled to the data bus system, wherein the memory includes computer usable program code;
a network communication device coupled to the data bus for sending and receiving data;
a processing unit coupled to the data bus system, wherein the processing unit executes the computer usable program code to:
associate calendar appointments of a first person with a virtual receptionist; and
notify a second person of a delay in response to a determination by the virtual receptionist that a start time associated with a calendar appointment between the first person and the second person will be delayed.

20. The system of claim 19, wherein the processing unit further executes the computer usable program code to dynamically update the calendar appointments of the first person based on the delay.
